(19) United States
(12) Patent Application Publication
(10) Pub. No.: US 2015/0108838 A1
(43) Pub. Date: Apr. 23, 2015

(54) SOLAR POWER SYSTEM FOR RETAIL ENVIRONMENTS

(71) Applicant: Rick A. Pierce, Las Cruces, NM (US)

(72) Inventor: Rick A. Pierce, Las Cruces, NM (US)

(73) Assignee: Tagnetics, Inc., Troy, OH (US)

(21) Appl. No.: 14/520,900

(22) Filed: Oct. 22, 2014

Related U.S. Application Data
(63) Continuation-in-part of application No. 14/300,689, filed on Jun. 10, 2014.
Application No. 14/300,689 is a continuation-in-part of application No. 14/262,927, filed on Apr. 28, 2014.
Application No. 14/262,927 is a continuation-in-part of application No. 14/217,902, filed on Mar. 18, 2014.
(60) Provisional application No. 61/894,044, filed on Oct. 22, 2013.

(51) Int. Cl. H02J 1/08; H02J 7/00; H04B 5/00

(52) U.S. Cl. CPC H02J 1/08; H04B 5/0031; H02J 7/0042
USPC 307/25

(57) ABSTRACT

A solar power system configured for use in a retail environment comprising at least one solar panel, a charge controller, a battery, and various electrical and electronic devices operatively connected to a low-voltage power control and distribution system which may include a Tag Area Controller, a system controller, a low-voltage wire loop, and at least one inductively coupled connector. At least one electronic shelf label may be powered from the solar power system.

### CROSS-REFERENCE TO RELATED APPLICATION

This application is a Continuation-in-Part of U.S. patent application Ser. No. 14/300,689 filed Jun. 10, 2014, which is a Continuation-in-Part of U.S. patent application Ser. No. 14/262,927 filed Apr. 28, 2014, which is a Continuation-in-Part of U.S. patent application Ser. No. 14/217,902 filed Mar. 18, 2014. This application claims priority to U.S. Provisional Patent Application Ser. No. 61/894,044 filed Oct. 22, 2013. The entirety of these applications are incorporated herein by reference.

### FIELD OF THE INVENTION

The present disclosure generally relates to solar power. More specifically, the present disclosure generally relates to generating electrical power using a system of solar arrays disposed in retail environments.

### BACKGROUND

Retails stores are consuming a growing amount of electrical power due to the addition of various electrical and electronic features such as electronic shelf tags, video monitor displays, lighted promotional displays, shelf lighting, inventory sensors, inventory control systems, temperature sensors, and the like. In the aggregate, these devices can consume a large amount of electrical power in a retail store.

Retailers are thus interested in ways to reduce the electrical power consumption of their stores. In the competitive market of retailing, removing these devices is not an option because most retailers believe they provide an edge over competitors. Retailers must look for creative solutions to reduce power consumption while maintaining existing electrical load.

The multitude of devices in retail stores today present a second problem: access to power. Many of these devices are powered by batteries. However, battery-powered devices are problematic for retailers because of their limited battery lifespan, limited power output, the high personnel and material costs to replace the batteries, and the high cost of disposing spent batteries.

Still others of these devices are powered by hard-wired connections to standard 120V/60 Hz electrical power. These hard-wired devices are expensive to install, may be subject to national and local electrical codes, and carry additional safety concerns such as the need for cabling to be encased in conduit. Still other devices are powered by low-voltage hard-wired systems, such as through inductive coupling of a 12V or 24V system. These low-voltage hard-wired systems carry substantial advantages; however, even these systems are hard to install in every area of a retail store. For example, retailers often use stand-alone, moveable displays that advertise, promote, or provide a retail item on a rolling cart. For these types of mobile applications, hard-wiring is not a desired solution.

### SUMMARY OF THE DISCLOSURE

The present disclosure is directed to a solar power system which obviates many of the deficiencies cited above. Specifically, the solar power system is able to reduce the retailer's reliance on electricity being supplied by the conventional power grid by generating electrical power from ambient light. The solar power system also introduces a flexibility that was previously not available by providing electrical power to mobile retail displays and other areas of a retail store that are difficult or impossible to provide with a hard-wired AC power supply.

In some embodiments, a solar-powered retail display system comprises a plurality of solar panels mounted in a retail environment; a battery; a charge controller, operably connected to the plurality of solar panels and the battery; at least one retail electronic device; and a system controller in wireless communication with the charge controller and at least one electronic device, wherein the system controller is configured to monitor performance of the solar-powered retail display system including at least: power received at the charge controller from the plurality of solar panels, power received at the charge controller from the battery or sent to the battery from the charge controller, and power sent from the charge controller to the at least one retail electronic device.

In some embodiments, a solar-powered retail display system comprises a first, second, and third solar panel connected in parallel to a charge controller, each of the first, second and third solar panels having a supply line and a return line connecting to a common supply line and a common return line which connect to the charge controller and wherein a first, second, and third pair of blocking diodes are connected across the supply line and the return line of each of the first, second, and third solar panel connections, respectively; a battery, operably connected to the charge controller; and at least one electronic shelf label operably connected to receive electrical power from the charge controller.

In some embodiments, a self-sustaining, mobile retail shelf system comprises an exterior frame having at least one shelf mounted therein and at least one solar panel mounted above the at least one shelf; a charge controller, operably connected to a battery and the at least one solar panel; a plurality of electronic shelf labels, inductively coupled to the charge controller and mounted to the front face of the at least one shelf; and a system controller, remote from the exterior frame and configured to wirelessly communicate with each of the plurality of electronic shelf labels.

The present disclosure is generally directed to a solar power system comprising at least one solar panel, a charge controller, a battery, and various electrical and electronic devices operatively connected to a low-voltage power control and distribution system which may include a Tag Area Controller, a system controller, a low-voltage wire loop, an inductively coupled connector, and the devices and systems described in commonly owned U.S. patent application Ser. No. 14/088,989, filed Nov. 25, 2013, entitled “Camera System with Inductive Powering of Wireless Camera Tags”; U.S. patent application Ser. No. 14/152,644, filed Jan. 10, 2014, entitled “Out of Stock Sensor”; U.S. patent application Ser. No. 14/152,678, filed Jan. 10, 2014, entitled “Inventory Control System”; U.S. patent application Ser. No. 14/262,927, filed Apr. 28, 2014, entitled “Lighted Mounting Apparatus”; U.S. patent application Ser. No. 14/300,689, filed Jun. 10, 2014, entitled “Retail Video Monitor Display”; U.S. Provisional Patent Application No. 61/894,032, filed Oct. 22, 2013, entitled “Temperature Sensor for Retail Environments”; and U.S. Provisional Patent Application No. 62/024,510, filed Jul. 15, 2014, entitled “Advertising Beacon for Retail Environments.” The disclosure of each of these applications is hereby incorporated by reference.

### BRIEF DESCRIPTION OF THE DRAWINGS

The foregoing and other advantages of the present disclosure will become apparent upon reading the following detailed description and upon reference to the drawings.

FIG. 1 is a simplified block diagram of a solar power system for retail environments in accordance with some embodiments of the present disclosure.

FIG. 2A is a simplified block diagram of an electric current flow configuration in conjunction with the charge controller in accordance with some embodiments of the present disclosure.

FIG. 2B is a simplified block diagram of an electric current flow configuration in conjunction with the charge controller in accordance with some embodiments of the present disclosure.

FIG. 3 is a simplified block diagram of a solar power system for retail environments in accordance with some embodiments of the present disclosure.

FIG. 4 is an isometric view of a mobile solar powered display unit in accordance with some embodiments of the present disclosure.

FIG. 5 is a simplified block diagram of a solar power system for retail environments in accordance with some embodiments of the present disclosure.

FIG. 6 is a schematic diagram of a power distribution system for a plurality of video monitor displays in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

The present disclosure is generally intended to be used in conjunction with a low-voltage, inductively-coupled system such as that disclosed in U.S. Pat. Nos. 5,537,126; 5,736,967; 6,089,453; 6,249,263; 6,271,807; and 6,844,821, which are herein incorporated in their entirety. However, the present disclosure may be used with additional systems and devices which employ inductive coupling to provide power and/or communication or control signals.

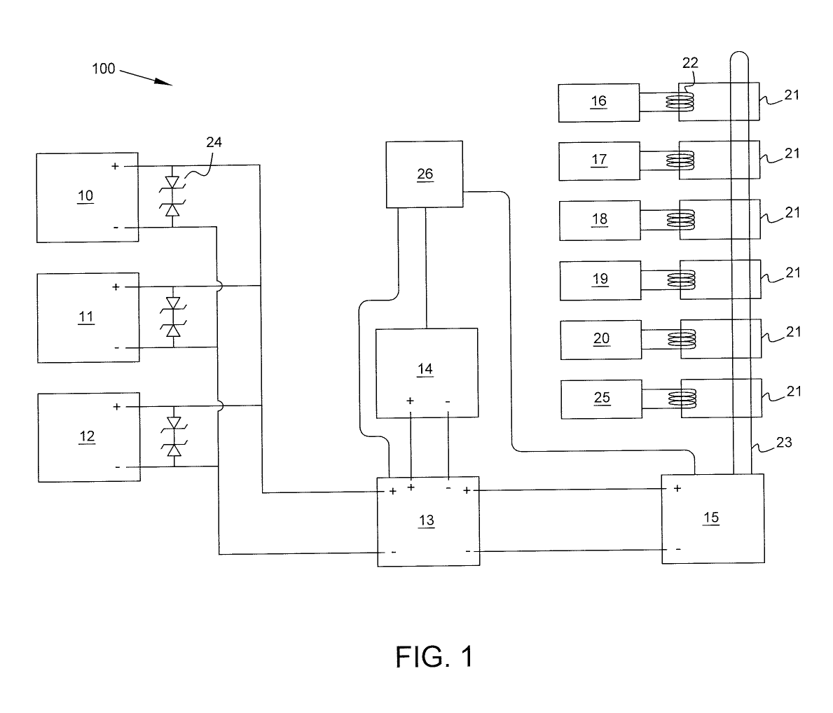

FIG. 1 is a block diagram of a solar power system 100 for retail environments in accordance with some embodiments of the present disclosure. In some embodiments, solar power system 100 comprises three solar panels 10, 11, and 12, a charge controller 13, battery 14, Tag Area Controller (TAC) 15, and various devices 16, 17, 18, 19, 20, and 25.

Solar panels 10, 11, and 12 are operatively connected in parallel to charge controller 13. In some embodiments, solar panels 10, 11, and 12 share a supply line (+) and return line (−) connecting to charge controller 13. In some embodiments, each solar panel 10, 11, and 12 has an individual supply line (+) and return line (−) connecting to a common supply line (+) and return line (−) which connects to charge controller 13. A battery 14 is operatively connected to charge controller 13. Charge controller 13 is operatively connected to TAC 15, from which emanates a low-voltage wire loop 23. Loop 23 provides power via inductive coupling connectors 21 to various devices. Devices may include but are not limited to electronic shelf labels 16, out-of-stock or inventory control sensors 17, video monitor displays 18, lighted promotional displays 19, shelf lighting 20, and temperature sensors 25.

In some embodiments, first solar panel 10 comprises a plurality of solar cells of a first type. In some embodiments, each solar cell of a first type has a 0.5 volt and 1.8 watt output. In some embodiments, these solar cells of a first type are disposed in three rows of sixteen cells to provide a total 24 volt output at a maximum of 43.2 watts.

In some embodiments, second solar panel 11 comprises a plurality of solar cells of a second type. In some embodiments, each solar cell of a second type has a 0.5 volt and 1.9 watt output. In some embodiments, these solar cells of a second type are disposed in three rows of sixteen cells to provide a total 24 volt output at a maximum of 45.6 watts.

In some embodiments, third solar panel 12 comprises a plurality of solar cells of a third type. In some embodiments, each solar cell of a third type has a 0.5 volt and 3.6 watt output. In some embodiments, these solar cells of a third type are disposed in six rows of eight cells to provide a total 24 volt output at a maximum of 60.0 watts.

In some embodiments, additional solar panels may be used, or first, second, and third solar panels 10, 11, 12 may be placed in an alternate configuration. In other embodiments, a single panel may be used, having solar cells of all the same type, or having a mixture of different types of solar cells.

In some embodiments, with first, second, and third solar panels 10, 11, and 12 operatively connected in parallel, a pair of blocking diodes 24 are connected across the supply and return lines of each solar panel connection as illustrated in FIG. 1. Blocking diodes 24 prevent electrical current from one side of the parallel connection from flowing to a second side. In some embodiments, blocking diodes 24 connected across first and second solar panels 10, 11, are three amp blocking diodes 24. In some embodiments, blocking diodes 24 connected across third solar panel 12 is ten amp blocking diode 24.

Battery 14 is operatively connected to charge controller 13 and supplies additional electrical power to devices 16, 17, 18, 19, 20, and 25 when solar panels 10, 11, and 12 cannot meet the device load. In some embodiments, battery 14 is a 24 volt battery. In other embodiments, battery 14 is two 12 volt batteries connected in series.

In some embodiments, battery 14 is replaced with a connection to standard 120 V, 60 Hz electrical outlet power. In other embodiments, battery 14 is replaced with a connection to a 240 V, 60 Hz or a 220 V, 50 Hz electrical outlet power. Charge controller 13 is connected to this standard power source and draws on the standard power source to augment power to devices 16, 17, 18, 19, 20, and 25 when solar panels 10, 11, and 12 cannot meet the device load. When solar panels 10, 11, and 12 produce power greater than device load, the excess power is sent to ground.

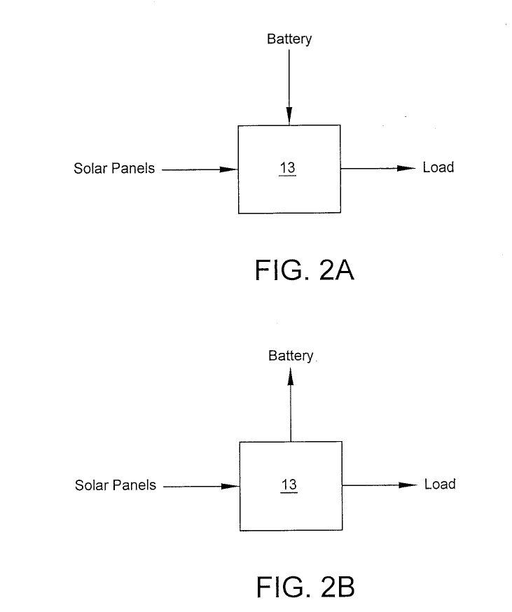

Charge controller 13 controls the flow of electricity between solar panels 10, 11, and 12; battery 14, and TAC 15. FIGS. 2A and 2B are block diagrams of electric current flow configurations in conjunction with the charge controller in accordance with some embodiments of the present disclosure.

FIG. 2A illustrates the electric current flow among system components when electrical power produced by solar panels 10, 11, and 12 is insufficient to meet the electrical load of the various devices. In this configuration, solar panels 10, 11, and 12 send their electrical output to charge controller 13. Charge controller 13 also pulls additional electricity from battery 14 to meet the electrical load. Charge controller 13 sends this combined electrical current downstream to TAC 15 and then on to devices 16, 17, 18, 19, 20, and 25.

FIG. 2B illustrates the electric current flow among system components when electrical power produced by solar panels 10, 11, and 12 is greater than the electrical load of the various devices. In this configuration, solar panels 10, 11, and 12 send their electrical output to charge controller 13. Charge controller 13 sends a portion of the electricity produced by the solar panels 10, 11, and 12 downstream to TAC 15 and then on to devices 16, 17, 18, 19, 20, and 25. Charge controller 13 also sends the surplus electricity to battery 14, charging the battery 14 for future use.

In some embodiments, charge controller 13 is a maximum power point tracking (MPPT) charger. In some embodiments, charge controller 13 is a model MPPT30 charge controller manufactured by Instapark, Inc.

In some embodiments, TAC 15 is a Tag Area Controller as used in a system of electronic shelf labels such as that disclosed in U.S. Pat. Nos. 5,537,126; 5,736,967; 6,249,263; 6,271,807; and 6,844,821. In other embodiments, TAC 15 is a power converter to convert electricity from the charge controller 13 to an appropriate voltage, amperage, and frequency for use by various devices 16, 17, 18, 19, 20, and 25.

In some embodiments the TAC 15 is further connected to a system controller 26. A system controller 26 may be implemented as a personal computer, a stand-alone computer, or other device. In some embodiments, the system controller 26 controls a plurality of TACs 15, with each TAC 15 responsible for controlling a plurality of devices in a specific area of a retail store. For example, in some embodiments a retail store is assigned a single system controller 26 while each aisle of the retail store is assigned a unique TAC 15.

In some embodiments, system controller 26 communicates wirelessly with TAC 15. In some embodiments, the system controller 26 is a personal computer. In other embodiments, the system controller 26 is connected to or in communication with a personal computer.

In some embodiments, system controller 26 communicates, via wire connection or wirelessly, with battery 14 and charge controller 13 to monitor the flow of electricity in solar power system 100. System controller 26 monitors power output of the solar panels 10, 11, and 12, electrical flow through charge controller 13, and charge of the battery 14. In some embodiments, system controller 26 provides a status indication to an output video monitor, enabling a system user to view the system status and monitor various system parameters. In some embodiments, system controller 26 is powered independent of the system 100 such as through a separate AC power connection and communicates wirelessly with the various system components.

In some embodiments, system controller 26 is a smart controller configured to collect and evaluate various performance parameters of solar power system 100, and the adjust system 100 configuration as necessary. As discussed above, system controller 26 can monitor power output of solar panels 10, 11, and 12. System 100 can further be configured with a switch associated with each of solar panels 10, 11, and 12. Thus system controller 26 can aid in balancing power supply against the load by opening and closing the switches to increase or decrease the number of solar panels online. In systems 100 configured for greater than three solar panels, controlling the number of solar panels providing power to charge controller 13 by opening and shutting switches associated with each solar panel is an effective means to control power supply.

System controller 26 can further monitor the load created by the various devices drawing power from the charge controller 13. System controller 26 can provide warnings and alarms based on high load, which can be calculated as an absolute predetermined value or as a value relative to the power supply from solar panels 10, 11, and 12. In some embodiments, system controller 26 provides warnings or alarms for high load via visual alarm, aural alarm, email, text message, phone call, or computer notification. Such warnings and alarms may also be indicated on the electronic shelf labels 16 of system 100.

In some embodiments, system controller 26 is further configured to collect data regarding system operating parameters and evaluate for system 100 optimization. For example, system controller 26 collects data regarding the power output of solar panels 10, 11, and 12 by time of day, date, and location in store. Such data is displayable in graph form at system controller 26. In some embodiments, system 100 is installed simultaneously in several locations throughout a retail store or installed sequentially at several locations throughout a retail store in order to determine which location provides best system performance, which is defined as either (1) highest power output from solar panels 10, 11, and 12 or (2) closest match of power output from solar panels 10, 11, and 12 and load of system 100.

In some embodiments, solar panels 10, 11, and 12 are mounted on selectably variable pitch frames which are configured to adjust the pitch of the solar panels, for example, between 0 degrees (lying flat, parallel to the ground) and 90 degrees (perpendicular to the ground). In some embodiments, system controller 26 is configured to additionally monitor and selectably adjust the pitch of at least one of solar panels 10, 11, and 12 to optimize power output of solar panels 10, 11, and 12.

In some embodiments, system controller 26 provides various notification functions such as fault detection; low charge warning and low charge alarm for the battery; and low power output warning and alarm for solar panels 10, 11, and 12.

In some embodiments, electrical and electronic devices of the solar power system 100 include electronic shelf labels 16, out-of-stock or inventory control sensors 17, video monitor displays 18, lighted promotional displays 19, shelf lighting 20, or temperature sensor 25. In some embodiment, each video monitor display 18 has an independent battery and solar power system 100 is used to recharge the battery of each video monitor display 18. In some embodiments, electrical and electronic devices of the solar power system 100 further includes retail advertising beacons (not pictured). Each device is connected to low-voltage wire loop 23 via inductive coupling connectors 21. The connection includes a wire coil 22 which is inductively coupled to wire loop 23, enabling the device to draw electrical power and communications signals from the TAC 15 or system controller.

In some embodiments, the devices are secured (i.e. powered off or in sleep mode) while the retail environment is closed to customers to reduce power consumption. In some embodiment, solar power system 100 includes a conventional plug for connecting the system 100 to a standard wall outlet to recharge battery 14 while the retail environment is closed to customers. In some embodiments, a system user monitors system controller 26 to ensure sufficient charging of battery 14 occurs and adjusts retail lighting to increase or decrease charging.

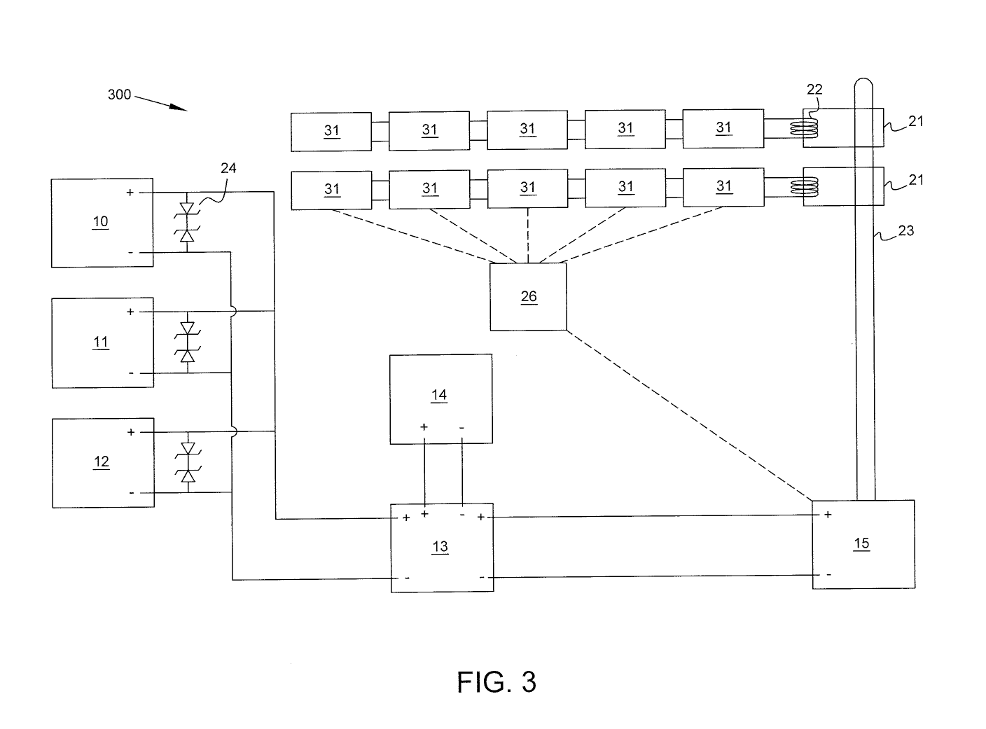

FIG. 3 is a block diagram of a solar power system 300 for retail environments in accordance with some embodiments of the present disclosure. In modified solar power system 300, system controller 26 communicates wirelessly with ESLs 31 and TAC 15.

In some embodiments, the solar power system 300 is configured to power only electronic shelf labels 16, 31. In FIG. 3, electronic shelf labels 31 are operatively connected in series such that a single inductive coupling connector 21 provides power for a plurality of electronic shelf labels 31.

In some embodiments, system controller 26 controls electronic shelf labels 31 via wireless communication. In such embodiments, each electronic shelf labels 31 includes a wireless transceiver for wirelessly communicating with and receiving control signals from system controller 26. Such control signals include, for example, a price to be displayed on the electronic shelf label 31, product information to be displayed, and light and contrast levels of the electronic shelf label 31 display.

In other embodiments, TAC 15 controls electronic shelf labels 31 via wireless communication. In still further embodiments, system controller 26 communicates wirelessly with TAC 15, which then transmits control signals to electronic shelf labels via wired inductive coupling connector 21.

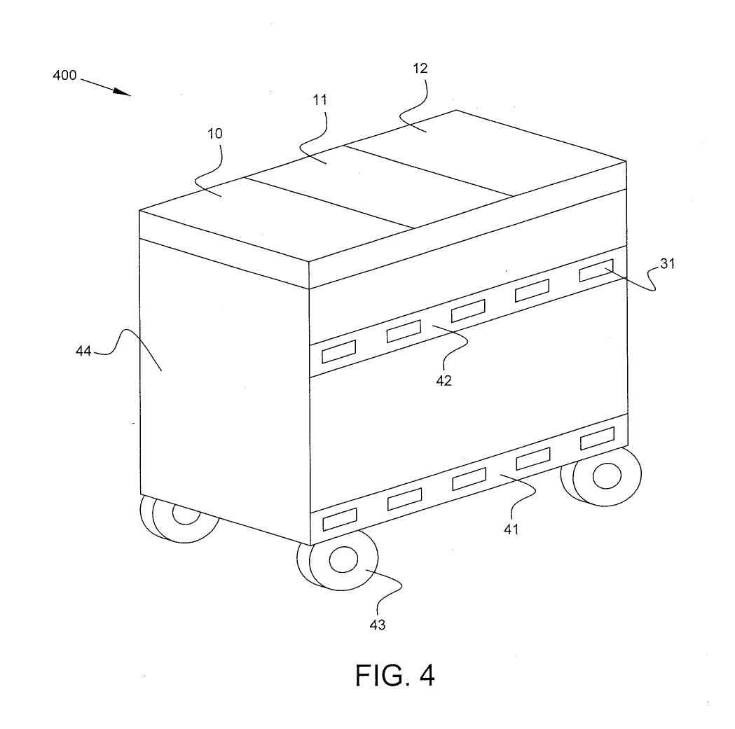

FIG. 4 is an isometric view of a mobile solar powered display unit 400 in accordance with some embodiments of the present disclosure. In some embodiments, mobile solar powered display 400 is self-sustaining, meaning it produces as much electric power as it consumes. Mobile solar powered display unit 400 comprises first solar panel 10, second solar panel 11, third solar panel 12, a mobile display unit having an external frame 44, at least one front electronic shelf label mounting plate 41, 42, and a plurality of electronic shelf labels 31. Not shown in the isometric view of FIG. 4 but also operatively connected in mobile solar powered display unit 400 are charge controller 13, battery 14, low-voltage wire loop 23, and at least one inductively coupled connector 21. In some embodiments, mobile solar powered display unit 400 further comprises a TAC 15.

Mobile solar powered display unit 400 is designed as a self-contained, stand-alone electronic shelf label 31 display powered by solar panels 10, 11, and 12. Such a display removes the need for retailers to provide battery power as the primary power source to such mobile displays or deal with the difficulties of providing a traditional hard-wired solution.

In some embodiments, the plurality of electronic shelf labels 31 are secured (i.e. powered off or in sleep mode) while the retail environment is closed to customers to reduce power consumption. In some embodiment, mobile solar powered display unit 400 includes a conventional plug for connecting the unit 400 to a standard wall outlet to recharge battery 14 while the retail environment is closed to customers. In some embodiments, battery 14 is charged while the retail environment is closed to customers by maintaining retail lighting energized to trickle charge the battery 14. In some embodiments, a system user monitors system controller 26 to ensure sufficient charging of battery 14 occurs and adjusts retail lighting to increase or decrease charging.

In some embodiments, the mobility of the external frame 44 is implemented with wheels 43.

In some embodiments, electronic shelf labels 31 communicate wirelessly with system controller 26 to receive communication and control signals. In other embodiments, communications and control signals are wirelessly transmitted from the system controller 26 to TAC 15, and then are transmitted via inductively coupled connections from TAC 15 to electronic shelf labels 31.

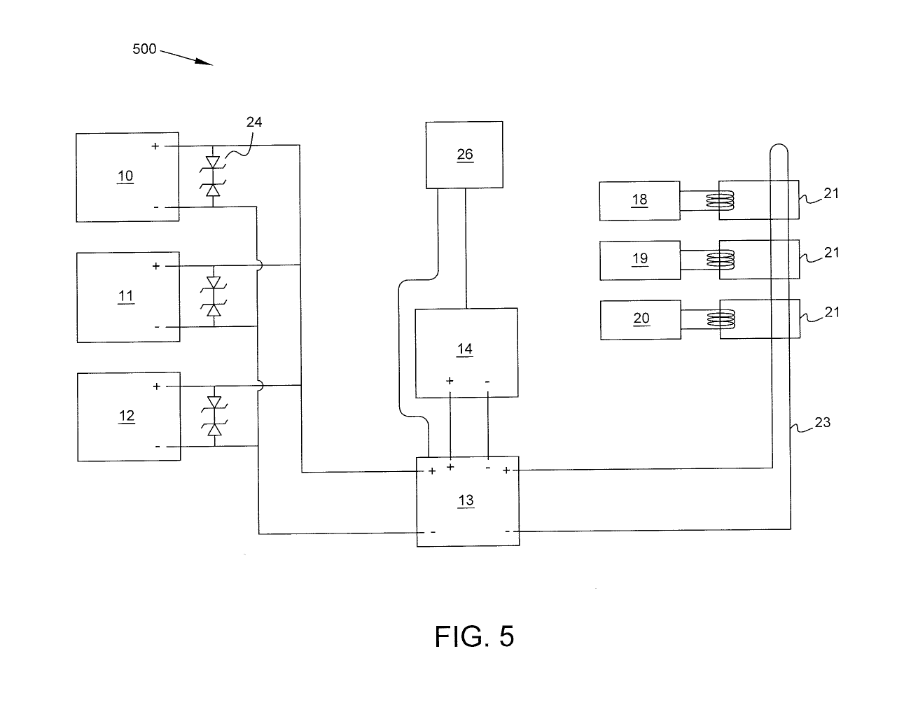

FIG. 5 is a block diagram of a solar power system 300 for retail environments in accordance with some embodiments of the present disclosure. In modified solar power system 500, TAC 15 is removed and charge controller 13 sends its output directly to wire loop 23. In this embodiment, the electrical output of charge controller 13 may be configured for use (i.e., proper voltage, frequency, and amperage) by the various downstream devices. In some embodiments, the electrical output of charge controller 13 may be processed by an additional power converter to be configured for use by the various downstream devices.

Modified solar power system 500 is primarily used when ESLs 16, 31, out-of-stock sensors 17, and temperature sensors 25 are not connected to wire loop 23. In some embodiments, these devices require both power and communications supplied via wire loop 23, which requires the inclusion of TAC 15. Modified solar power system 500 is therefore generally used when video monitor displays 18, lighted promotional displays 19, shelf lighting 20 are connected to wire loop 23.

In some embodiments, solar power systems 100, 300 produce 24 volts of electricity at 3 amps and a maximum of 72 watts.

In some embodiments, solar power systems 100, 300 require a minimum light intensity of 1,000 LUX to produce sufficient electrical power.

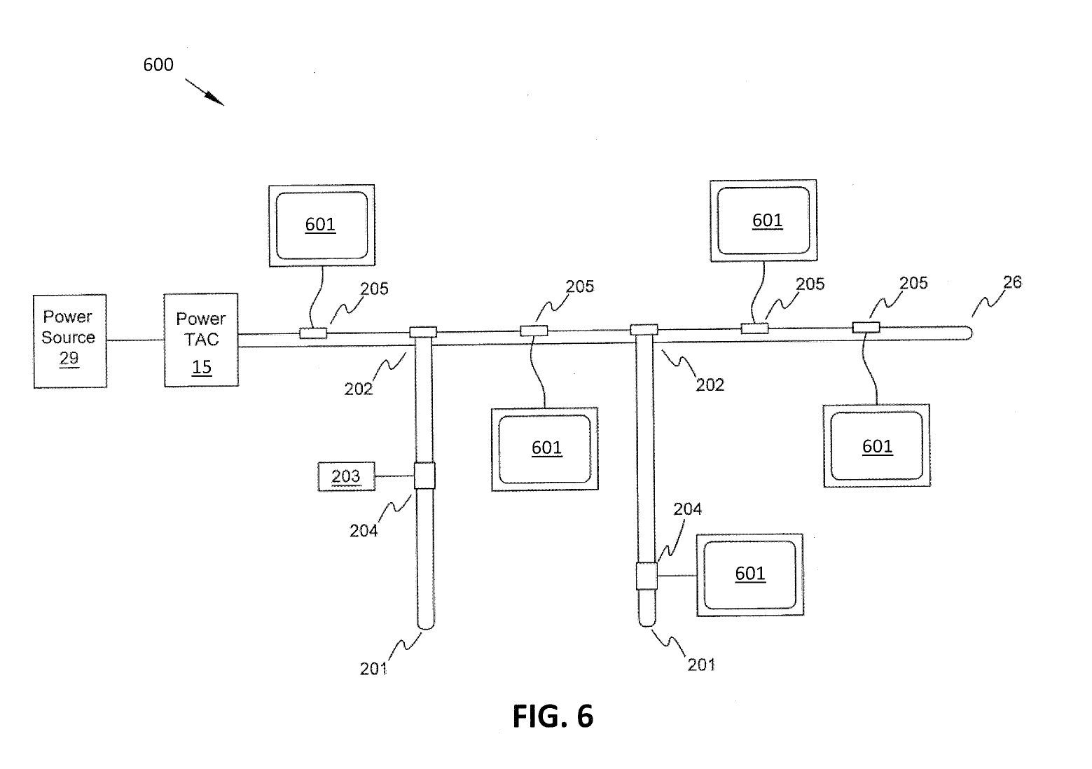

FIG. 6 is a schematic diagram of another embodiment of a video monitor power distribution system 600 for at least one electronic device 601 in accordance with some embodiments. In some embodiments, power distribution system 600 distributes power to a plurality of electronic devices 601. In some embodiments, power distribution system 600 additionally distributes power to a plurality of electronic shelf labels (ESLs) 203.

In some embodiments power source 29 is a standard wall outlet well known in the art. Electrical power flows through a Power Tag Area Controller 15 to a power stringer 26. In some embodiments the power stringer 26 is called the primary distribution loop. In some embodiments power stringer 26 distributes power at between 45 and 50 VAC, 50 KHz, and 1 ampere. A frequency of 50 KHz was selected in part to comply with applicable regulatory requirements.

Power stringer 26 conveys power from the Power TAC 15 to at least one electronic device 601. Each electronic device 601 is connected to the power stringer 26 via a power converter 205. In some embodiments, power stringer 26 additionally conveys power to at least one secondary distribution loop 201. A secondary distribution loop 201 may also be referred to as a riser. Each secondary distribution loop 201 is connected to power stringer 26 via a primary-secondary connection 202. In some embodiments, the primary-secondary connection 202 is a step-down transformer which maintains the secondary distribution loop 201 at a lower voltage, frequency, and/or amperage than the power stringer 26. In other embodiments, the primary-secondary connection 202 maintains the secondary distribution loop 201 at the same voltage, frequency, and amperage as power stringer 26.

In the embodiments, such as that pictured in FIG. 6, a plurality of electronic devices 601 are connected to a single power source 29 using a single power stringer 26 and a plurality of power converters 205. In some embodiments, a plurality of electronic devices 601 may receive electrical power by a plurality of power sources 29 or a plurality of power stringers 26. In some embodiments, the power source 29 is connected to a power stinger 26 via inductive coupling. In some embodiments, at least one electronic device 601 is powered via the secondary distribution loop using a power coupler 204.

In some non-limiting embodiments, power converter 205 and power coupler 204 are those described in U.S. patent application Ser. No. 14/217,902.

In some embodiments, Power TAC 15 is a Tag Area Controller as used in a system of electronic shelf labels such as that disclosed in U.S. Pat. Nos. 5,537,126; 5,736,967; 6,249,263; 6,271,807; and 6,844,821. In other embodiments, Power TAC 15 may be removed from power distribution system 600 allowing each power converter 205 to connect to the power source 29. In some embodiments, the Power TAC 15 is an electrical power strip. From power converter 205 power is provided to a promotional glass holder 2. In some embodiments, the control for a Power TAC 15 is provided by a general purpose computer processor. In some embodiments, the electronic shelf labels 203 are connected to the secondary distribution loop via a power coupler 204.

In some embodiments, a plurality of electronic devices 601 receive electrical power from a plurality of power sources 29 or a plurality of low voltage power stringers 26.

In some embodiments, electronic devices 601 are any one or combination of video monitors, lighted mounting apparatuses, temperature sensors, out of stock sensors, inventory control sensors, or advertising beacons.

In some embodiments, power source 29 comprises solar panels 10, 11, 12, charge controller 13, and battery 14, configured as illustrated in FIG. 1.

The present disclosure includes many advantages over the existing art. Most notably, generating electrical power with solar panels allows a retailer to reduce electricity consumption from the conventional power grid in a retail store without forgoing the use of popular and effective electrical and electronic devices. The mobile solar powered display unit of FIG. 4 provides a further solution to the problem of providing electrical power to mobile units by creating a stand-along mobile display powered from solar power. Further, low voltage power used in solar power systems 100, 300 is less expensive to install than a standard 120 V, 220 V, or 240 V electrical system. Due to its low voltage, this power also has significantly fewer safety concerns and code requirements. The present disclosure is also eliminates the need to change batteries—a time- and labor-intensive process that adds to a retailer's expense of maintaining a promotional system. Finally, the disclosed system is more reliable than prior art systems using devices which are individually battery-powered because it does not require frequent replacement of the power source and provides hard-wired communications between devices and the area and system controllers.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

What is claimed is:

1. A solar-powered retail display system, comprising:
a plurality of solar panels mounted in a retail environment;
a battery;
a charge controller, operably connected to the plurality of solar panels and the battery;
at least one retail electronic device; and
a system controller in wireless communication with the charge controller and at least one electronic device, wherein the system controller is configured to monitor performance of the solar-powered retail display system including at least: power received at the charge controller from the plurality of solar panels, power received at the charge controller from the battery or sent to the battery from the charge controller, and power sent from the charge controller to the at least one retail electronic device.

2. The system of claim 1, wherein the at least one retail electronic device is selected from a list consisting of: an electronic shelf label, a retail video monitor, a lighted mounting apparatus, a temperature sensor, an out of stock sensor, an inventory control sensor, and an advertising beacon.

3. The system of claim 2, wherein the at least one retail electronic device is a plurality of electronic shelf labels, each of the electronic shelf labels in wireless communication with a system controller and wherein the system controller supplies price information for display on the electronic shelf label.

4. The system of claim 3, further comprising a selectably variable pitch frame, the plurality of solar panels mounted thereon and the system controller configured to select the pitch of at least one of the plurality of solar panels.

5. The system of claim 1, wherein the at least one retail electronic device is at least one inventory control sensor in wireless communication with a system controller.

6. The system of claim 5, wherein the system controller maintains real-time inventory of at least one type of product disposed on the inventory control sensor.

7. A solar-powered retail display system, comprising:
a first, second, and third solar panel connected in parallel to a charge controller, each of the first, second and third solar panels having a supply line and a return line connecting to a common supply line and a common return line which connect to the charge controller and wherein a first, second, and third pair of blocking diodes are connected across the supply line and the return line of each of the first, second, and third solar panel connections, respectively;
a battery, operably connected to the charge controller; and
at least one electronic shelf label operably connected to receive electrical power from the charge controller.

8. The system of claim 7, further comprising a system controller in wireless communication with the at least one electronic shelf label, wherein the system controller is configured to monitor performance of the solar-powered retail display system including at least: power received at the charge controller from the first, second, and third solar panels; power received at the charge controller from the battery or sent to the battery from the charge controller; and power sent from the charge controller to the at least one electronic shelf label.

9. The system of claim 8, further comprising a first, second, and third switch connected in the supply line of the first, second, and third solar panel, respectively, wherein the system controller is configured to open and shut the at least one of the first, second, and third switch to assist in balancing power output of the first, second, and third solar panel against the electric load of the at least one electronic shelf label.

10. The system of claim 9, further comprising an outlet plug configured to selectably connect the charge controller or battery to a power source.

11. A self-sustaining, mobile retail shelf system, comprising:
an exterior frame having at least one shelf mounted therein and at least one solar panel mounted above the at least one shelf;
a charge controller, operably connected to a battery and the at least one solar panel;
a plurality of electronic shelf labels, inductively coupled to the charge controller and mounted to the front face of the at least one shelf; and
a system controller, remote from the exterior frame and configured to wirelessly communicate with each of the plurality of electronic shelf labels.

12. The system of claim 11, further comprising a plurality of retail products disposed on the at least one shelf, said plurality of retail products having at least a first type and second type, wherein one of the plurality of electronic shelf labels is associated with each type of retail product.

13. The system of claim 12, wherein the system controller is further operably connected to the charge controller and configured to monitor power output from the at least one solar panel and electric load of the plurality of electronic shelf labels.

14. The system of claim 13, wherein the system controller is further configured to provide an alarm when power output of the at least one solar panel is insufficient to meet the electric load of the plurality of electronic shelf labels.

15. The system of claim 13, wherein a control signal transmitted from the system controller to one of the plurality of electronic shelf labels includes a price to be displayed on the electronic shelf label.

16. The system of claim 15, further comprising an outlet plug configured to selectably connect the charge controller or battery to a power source.

17. The system of claim 16, further comprising four wheels attached to the exterior frame to provide mobility to the retail shelf system.

18. The system of claim 17, further comprising an advertising beacon operably connected for receiving power from the charge controller and configured to provide short-range broadcast advertisements to a customer's mobile device.

19. The system of claim 14, further comprising at least one switch associated with the at least one solar panel, wherein the system controller is configured to open and shut the at least one switch to assist in balancing power output of the at least one solar panel against the electric load of the plurality of electronic shelf labels.

20. The system of claim 14 further comprising a tag area controller disposed within the external frame and operably connected between the charge controller and the plurality of electronic shelf labels, wherein the system controller communicates wirelessly with the tag area controller and the tag area controller transmits control signals to the plurality of electronic shelf labels via inductively coupled connections.
